(19) United States
(12) Patent Application Publication
(10) Pub. No.: US 2017/0107141 A1
(43) Pub. Date: Apr. 20, 2017

(54) GLASS FOR CHEMICAL STRENGTHENING AND CHEMICALLY STRENGTHENED GLASS

(71) Applicant: ASAHI GLASS COMPANY, LIMITED, Chiyoda-ku (JP)

(72) Inventors: Junko MIYASAKA, Chiyoda-ku (JP); Seiki OHARA, Chiyoda-ku (JP)

(73) Assignee: ASAHI GLASS COMPANY, LIMITED, Chiyoda-ku (JP)

(21) Appl. No.: 15/393,575

(22) Filed: Dec. 29, 2016

Related U.S. Application Data
(63) Continuation of application No. PCT/JP2015/069154, filed on Jul. 2, 2015.

(30) Foreign Application Priority Data
Jul. 4, 2014 (JP) 2014-138894

(51) Int. Cl. C03C 3/087; C03B 25/04; C03C 21/00

(52) U.S. Cl. CPC C03C 3/087; C03C 21/002; C03B 25/04

(57) ABSTRACT

There are provide a glass for chemical strengthening suitable for a display member, having a low compaction and a high accuracy of film forming and patterning on a glass plate (causing less positional displacement) even in a glass plate manufactured by the fusion method or the like at a high cooling rate in glass forming, in a heat treatment at a low temperature (150° C. to 300° C.) in manufacturing the display member, and a chemically strengthened glass obtained using the glass for chemical strengthening. A glass for chemical strengthening obtained by melting and cooling a glass raw material includes, in mass percentage based on oxides, 61% to 75% of SiO₂, 2.5% to 10% of Al₂O₃, 6% to 12% of MgO, 0.1% to 8% of CaO, 14% to 19% of Na₂O, and 0% to 1.8% of K₂O.

### CROSS-REFERENCE TO RELATED APPLICATIONS

This application is a continuation of prior International Application No. PCT/JP2015/069154 filed on Jul. 2, 2015, which is based upon and claims the benefit of priority from Japanese Patent Applications No. 2014-138894 filed on Jul. 4, 2014; the entire contents of all of which are incorporated herein by reference.

### FIELD

The present invention relates to a glass for chemical strengthening and a chemically strengthened glass used in uses such as various touch panels, various display panels and the like, for example, having a conductive film or the like patterned on the glass.

### BACKGROUND

A glass plate for chemical strengthening can be manufactured using soda lime silicate glass or alkali aluminosilicate glass by various forming methods such as a float method, a roll-out method, a fusion method and the like. The float method being a forming method of drawing a glass plate in a horizontal direction can ensure a sufficient length of a slow cooling furnace, whereas a method of forming the glass plate in a vertical direction such as the fusion method has a constraint in length of the slow cooling furnace, leading to insufficient slow cooling time. The insufficient slow cooling time leads to an increase in cooling rate after forming the glass plate, resulting in increased shrinkage (hereinafter, referred to as “compaction”) in dimension of the glass plate due to the stabilization phenomenon of glass in a thermal process when patterning a transparent conductive film or the like on the glass plate. This brings about a problem of decreasing the accuracy in film forming and patterning (refer to, for example, Patent Reference 1 (JP-A-2009-196879)).

### SUMMARY

An object of the present invention is to provide a glass for chemical strengthening suitable for a display member, having a low compaction and a high accuracy of film forming and patterning on a glass plate (causing less positional displacement) even in a glass plate manufactured by the fusion method or the like at a high cooling rate in glass forming or a glass plate manufactured by the float method at an increased cooling rate, in a heat treatment at a low temperature (150° C. to 300° C.) in manufacturing a touch panel such as an electrostatic capacitance type touch panel, and to provide a chemically strengthened glass obtained using the glass for chemical strengthening. Note that the cooling rate in glass forming refers to a cooling rate of the glass plate in a region from a glass transition point +50° C. to the glass transition point −120° C. in the slow cooling process after the glass raw material is melted and formed into a plate shape. Hereinafter, the glass transition point may be described as “Tg” in the description.

To achieve the above object, the present invention provides a glass for chemical strengthening obtained by melting and cooling a glass raw material, including, in mass percentage based on oxides,

61% to 75% of SiO₂,

2.5% to 10% of Al₂O₃,

6% to 12% of MgO,

0.1% to 8% of CaO,

14% to 19% of Na₂O, and

0% to 1.8% of K₂O.

The present invention provides a chemically strengthened glass obtained by chemically strengthening the above glass for chemical strengthening of the present invention.

The glass for chemical strengthening of the present invention has a low compaction in the heat treatment at a low temperature (150° C. to 300° C.) in the manufacturing process of the display member, for example, a compaction (C1) of 25 ppm or less by a later-described measuring method when it is formed into a plate shape, causing less positional displacement in film-forming and patterning on the glass plate. Accordingly, the glass for chemical strengthening of the present invention can be preferably used, in particular as a glass for chemical strengthening for an integrated-type cover glass, for a touch panel sensor coping with large size and high definition of a panel, high speed, high weather resistance, high functionality, and high reliability of a display frame, and built-in of an IC circuit of a driver or the like.

Further, the glass for chemical strengthening of the present invention is also applicable to glass manufactured by the forming method at a high cooling rate, for example the fusion method or the float method at an increased cooling rate. Further, the chemically strengthened glass obtained by chemically strengthening the glass for chemical strengthening of the present invention is high in surface compressive stress and is likely to have a surface compressive stress layer deep therein, and has a high strength as a display member.

### DETAILED DESCRIPTION

Hereinafter, embodiments of the present invention will be described.

### <Glass for Chemical Strengthening>

A glass for chemical strengthening of this embodiment is a glass for chemical strengthening obtained by melting and cooling a glass raw material, including following components in following amounts, in mass percentage based on oxides,

61% to 75% of SiO₂,

2.5% to 10% of Al₂O₃,

6% to 12% of MgO,

0.1% to 8% of CaO,

14% to 19% of Na₂O, and

0% to 1.8% of K₂O.

In this description, “%” used for explanation of the composition of glass indicates the mass percentage based on an oxide unless otherwise stated.

The reason why the composition in the glass for chemical strengthening of this embodiment is limited to the above composition, will be described below in a relation with preferable glass characteristics. Note that the glass characteristic (1) is a characteristic of the glass for chemical strengthening itself, and the glass characteristic (2) is a characteristic expressed when the glass is made into a chemically strengthened glass.

[Glass Characteristic (1)]

### (Compaction (C1))

Compaction (C1) is an index measured by the following method, for measuring the degree of compaction of the glass for chemical strengthening by a heat treatment at low temperature.

(Measuring Method)

A sample (100 mm×10 mm×1 mm) is heated up to the glass transition point +50° C., retained at the temperature for 1 minute, and then cooled down to room temperature at a temperature drop rate of 50° C./min, and thereafter indentations are made at two positions at an interval of A1 (A1=90 mm) in the long side direction on the surface of the sample using the Vickers hardness testing machine while observing the sample under an optical microscope. The sample with indentations is heated up to 300° C. at a temperature rise rate of 100° C./h (=1.6° C./min), retained at 300° C. for 1 hour, and then cooled down to room temperature at a temperature drop rate of 100° C./h, an interval B1 (mm) between the indentations is measured under the optical microscope, and the compaction (C1) is found by the following expression.

Compaction (C1) [ppm]=(A1−B1)/A1×10⁶

The glass for chemical strengthening of this embodiment preferably has a compaction (C1) of 25 ppm or less. The compaction (C1) is more preferably 23 ppm or less, furthermore preferably 21 ppm or less, and most preferably 18 ppm or less. When the compaction (C1) is 25 ppm or less, positional displacement is less likely to occur on the glass plate in film-forming and patterning due to the heat treatment at a low temperature (150° C. to 300° C.) in a manufacturing process of a display member after chemical strengthening.

(Glass Transition Point (Tg))

The glass transition point (Tg) of the glass for chemical strengthening of this embodiment is preferably not lower than 560° C. nor higher than 720° C. The Tg of the glass for chemical strengthening of this embodiment falling within the above range is preferable for decreasing the compaction (C1) The Tg is preferably 570° C. or higher, more preferably 575° C. or higher, and furthermore preferably 580° C. or higher.

(Average Coefficient of Linear Thermal Expansion (CTE))

The average coefficient of linear thermal expansion (CTE) of the glass for chemical strengthening of this embodiment at 50° C. to 350° C. measured according to JIS R 1618 (2002) is preferably 150×10⁻⁷/° C. or less. The CTE falling within the above range is preferable particularly in terms of display quality because of less variation in dimension in the manufacturing process of the display member and less influence on the quality (residual stress and photoelastic effect) due to the stress in bonding to a display panel of a liquid crystal display and the like. Note that in this description, the CTE refers to the average coefficient of linear thermal expansion (CTE) at 50° C. to 350° C. measured according to JIS R 1618 (2002) unless otherwise stated.

The CTE is more preferably 120×10⁻⁷/° C. or less and furthermore preferably 100×10⁻⁷1° C. or less. Further, in the case of using soda lime glass for the glass plate for a display panel, the CTE is preferably 65×10⁻⁷/° C. or higher in terms of thermal expansion difference between them.

(Devitrification Property (T_{id}))

The devitrification property (T_{id}) is an index relating to occurrence of devitrification given by the following expression (1).

T_{id}=T₄−_{T}L (1)

In expression (1), T₄ is a temperature at which the viscosity becomes 10⁴ dPa·s, and T_{L} is a devitrification temperature (T_{L}). The devitrification temperature (T_{L}) concretely refers to the highest value of the temperature of a glass grain in which crystals precipitate when glass is crushed into glass grains of about 2 mm in a mortar, the glass grains are set out on a platinum boat and subjected to heat treatment for 24 hours in increments of 10° C. in a temperature gradient furnace.

The devitrification property (T_{id}) is preferably −50° C. to 350° C. The devitrification property (T_{id}) is more preferably −30° C. or higher and particularly preferably −10° C. or higher. When the devitrification property (T_{id}) falls within the above range, devitrification is less likely to occur. In particular, for manufacture without possibility of devitrification in the float method, the devitrification property (T_{id}) is preferably 0° C. or higher, more preferably 10° C. or higher, and furthermore preferably 20° C. or higher.

(High-Temperature Viscosity)

As the index measuring the viscosity at high temperature, a temperature (T₂) at which the viscosity becomes 10² dPa·s is set. The T₂ is preferably 1600° C. or lower from the viewpoint of the meltability of the raw material, more preferably 1570° C. or lower, and furthermore preferably 1550° C. or lower.

(Specific Gravity)

The glass for chemical strengthening of this embodiment has preferably a specific gravity of 2.55 or less to reduce the weight of the display member, more preferably 2.50 or less, and furthermore preferably 2.48 or less. Note that in consideration of ease of ensuring other physical properties, the glass for chemical strengthening of this embodiment has a specific gravity of 2.40 or more. The specific gravity can be measured by the Archimedes method.

[Glass Characteristic (2)]

### (Compaction (C2))

Compaction (C2) is an index measured by the following method, for measuring the degree of compaction of the chemically strengthened glass by a heat treatment at low temperature.

(Measuring Method)

A sample (100 mm×10 mm×1 mm) is prepared, and indentations are made at two positions at an interval of A2 (A2=90 mm) in the long side direction on the surface of the sample using the Vickers hardness testing machine while observing the sample under the optical microscope. The sample with indentations is heated up to 300° C. at a temperature rise rate of 100° C./h (=1.6° C./min), retained at 300° C. for 1 hour, and then cooled down to room temperature at a temperature drop rate of 100° C./h, an interval B2 (mm) between the indentations is measured under the optical microscope, and the compaction (C2) is found by the following expression.

Compaction (C2) [ppm]=(A2−B2)/A2×10⁶

The chemically strengthened glass obtained from the glass for chemical strengthening of this embodiment preferably has a compaction (C2) of 25 ppm or less. The compaction (C2) is more preferably 23 ppm or less, furthermore preferably 21 ppm or less, and most preferably 18 ppm or less. When the compaction (C2) is 25 ppm or less, positional displacement is less likely to occur on the glass plate in film-forming and patterning due to the heat treatment at a low temperature (150° C. to 300° C.) in a manufacturing process of the display member.

(Surface Compressive Stress (CS))

The surface compressive stress (CS) is one of indexes measuring the strengthened characteristics of the chemically strengthened glass obtained by performing alkali ion exchange on the surface of the glass by chemical strengthening the glass for chemical strengthening. The CS can be measured utilizing the briefringence, and is measured by, for example, a surface stress meter FSM-6000 (manufactured by Orihara Industrial Co., Ltd.). The CS is preferably 300 MPa or more, more preferably 500 MPa or more, and furthermore preferably 600 MPa or more.

(Depth of Surface Compressive Stress Layer (DOL))

The depth of surface compressive stress layer (DOL) is one of indexes measuring the strengthened characteristics of the chemically strengthened glass along with the CS. The DOL indicates the depth of the layer subjected to exchange of alkali ions existing on the surface, namely a surface compressive stress layer, of the chemically strengthened glass. The DOL can be measured by, for example, the surface stress meter FSM-6000 (manufactured by Orihara Industrial Co., Ltd.). The DOL is preferably 8 μm or more, more preferably 9 μm or more, furthermore preferably 10 μm or more, and particularly preferably 11 μm or more.

[Composition of Glass for Chemical Strengthening]

### (SiO₂)

SiO₂ is known as a component forming a network structure in a glass microstructure and is a basic component constituting glass. The content of SiO₂ is 61% or more, preferably 62% or more, more preferably 63% or more, and furthermore preferably 64% or more. Further, the content of SiO₂ is 75% or less, preferably 73% or less, and more preferably 71% or less. The content of SiO₂ of 61% or more is superior in stability as glass, heat resistance, chemical durability, weather resistance, and in decreasing the specific gravity, compaction (C1), compaction (C2) (hereinafter, they are collectively referred to as compaction (C)), and CIE. On the other hand, the content of SiO₂ of 75% or less is superior in decreasing the viscosity of glass in melting to keep good meltability and in formability.

(Al₂O₃)

Al₂O₃ has a function of improving the ion exchange performance in the chemical strengthening and has a high function of improving, in particular, the CS. Al₂O₃ is also a component that increases the Tg of glass, improves the weather resistance, the heat resistance and the chemical durability, enhances the Young's modulus, and keeps the CTE and the compaction (C) low. Al₂O₃ also has a function of suppressing entry of tin from the bottom surface in float-forming. Al₂O₃ further has a function of suppressing movement of alkaline ions in the glass to a transistor element of an IC circuit of a sensor, a driver or the like to thereby suppress deterioration in performance of the sensor or the like. The content of Al₂O₃ is 2.5% or more, preferably 3% or more, more preferably 4% or more, and furthermore preferably 5% or more. Further, the content of Al₂O₃ is 10% or less, preferably 9% or less, and more preferably 8% or less.

When the content of Al₂O₃ is 2.5% or more, a desired CS value is obtained by alkali ion exchange, and such an effect of suppressing entry of tin in manufacture and an effect of suppressing the deterioration in performance of the sensor or the like as a product are further obtained. On the other hand, the content of Al₂O₃ of 10% or less is superior in formability such as decreasing the viscosity of glass in melting on a soda lime glass product line, suppressing deterioration in meltability, and improving the devitrification property because the devitrification temperature is not greatly increased even with a high viscosity of glass.

(MgO)

MgO is a component stabilizing glass, and is an essential component. The content of MgO is 6% or more, preferably 7% or more, more preferably 7.5% or more, and furthermore preferably 8% or more. Further, the content of MgO is 12% or less, preferably 11% or less, and more preferably 10.5% or less. When the content of MgO is 6% or more, the chemical resistance and the weather resistance of glass are improved, and the meltability at high temperature is improved to cause less devitrification. On the other hand, when the content of MgO is 12% or less, less occurrence of devitrification is maintained, resulting in a sufficient ion exchange rate and keeping the CTE and the compaction (C) at low values.

(CaO)

CaO is a component stabilizing glass, and is an essential component. CaO is a component having of an effect of decreasing the viscosity of glass in melting to accelerate melting and improve the devitrification property. However, since CaO tends to inhibit exchange of alkali ions, it is preferable to decrease its content when the DOL is desired to be increased. Further, since CaO when contained tends to increase the compaction (C), its content is appropriately adjusted so that the value of the compaction (C) falls within the above-described preferable range. The content of CaO is 0.1% or more, preferably 0.4% or more, and more preferably 0.8% or more.

The content of CaO is 8% or less, preferably 6% or less, more preferably 5% or less, and furthermore preferably 4% or less. When the content of CaO is 8% or less, a sufficient ion exchange rate is maintained, resulting in a desired DOL.

On the other hand, to improve the chemical resistance, the content of CaO is preferably 0.5% or more, more preferably 1% or more, furthermore preferably 2% or more, and still furthermore preferably 3% or more.

(Na₂O)

Na₂O is an essential component that forms a surface compressive stress layer by alkali ion exchange, and has a function of deepening the DOL. Na₂O further has an effect of decreasing the high-temperature viscosity and the devitrification temperature of glass to improve the devitrification property, and is a component that improves the meltability and formability of glass. The content of Na₂O is 14% or more, preferably 14.5% or more, more preferably 15% or more, and particularly preferably 16% or more. Further, the content of Na₂O is 19% or less, preferably 18% or less, and more preferably 17% or less.

When the content of Na₂O is 14% or more, a desired surface compressive stress layer can be formed by ion exchange. On the other hand, when the content of Na₂O is 19% or less, a sufficient weather resistance can be obtained.

Note that in the case of keeping the compaction (C) low as a primary purpose, the content of Na₂O is preferably set to 15.5% or less, in molar percentage based on an oxide. This produces an effect of suppressing the increase in the compaction (C) and the CTE, and the deterioration in the chemical durability and the weather resistance. Further, in this case, the Tg is preferably lower than 580° C. from the viewpoint of suppressing the deterioration due to heat of a glass forming facility.

The content of Na₂O when more than 15.5% in molar percentage based on an oxide is advantageous in terms of being capable of further deepening the DOL. As described above, as for the content of Na₂O, the decrease in the compaction (C) and the increase in the DOL are in a reciprocal relation, and the content of Na₂O is appropriately selected according to the contents of other components and the glass characteristics required depending on the use.

(K₂O)

K₂O is not essential but may be contained because of an effect of increasing the ion exchange rate and deepening the DOL. K₂O is a component that may be contained because of further having an effect of decreasing the viscosity of glass in melting to accelerate melting and improve the devitrification property. On the other hand, too much K₂O leads to a failure to obtain a sufficient CS and causes an increase in the compaction (C).

The amount of K₂O when contained is 1.8% or less, preferably 1.5% or less, more preferably 1.1% or less, furthermore preferably 0.8% or less, and most preferably 0.5% or less. When the content of K₂O is 1.8% or less, a sufficient CS can be obtained and the increase in the compaction (C) falls within an allowable range. From the viewpoint of keeping the compaction (C) within an appropriate range, it is particularly preferable to contain substantially no K₂O. Note that in this description, “contain substantially no” means containing nothing other than inevitable impurities mixed from a raw material or the like, namely, not intentionally containing.

(Total Amount of Alkaline-Earth Metal Oxides)

The above-described MgO and CaO as essential components in the glass for chemical strengthening of this embodiment and SrO and BaO being other components which will be described later are alkaline-earth metal oxides and have the following common functions. Hereinafter, MgO, CaO, SrO and BaO are collectively referred to as “MO”. MO has an effect of decreasing the viscosity of glass in melting to accelerate melting and improve the devitrification property. MO is a component further effective of adjusting the Tg and a strain point, and also has a function of improving the weather resistance of glass. However, too much MO contained may increase the CTE and the compaction (C).

From the above viewpoint, the content of MO in total is preferably 6.1% or more, more preferably 7% or more, and furthermore preferably 8% or more. Further, the content of MO in total is 15% or less, more preferably 13% or less, and furthermore preferably 12% or less.

(Relation Between the Total Amount of Alkali Metal Oxides and the Content of Each Component)

The above-described Na₂O and K₂O and Li₂O being the other component which will be described later are alkali metal oxides and have the following common functions. Hereinafter, Na₂O, K₂O and Li₂O are collectively referred to as “M′₂O”. Note that the function relating to chemical strengthening is different in each component, and is as described for each component.

M′₂O contained in the glass for chemical strengthening of this embodiment has of an effect of decreasing the viscosity of glass in melting to accelerate melting and improve the devitrification property. However, too much M′₂O contained may increase the compaction (C).

From the above viewpoint, the content of M′₂O in total is preferably 14% or more, more preferably 15% or more, and furthermore preferably 16% or more. Further, the content of M′₂O in total is preferably 18% or less, and more preferably 17% or less.

Here, to decrease the compaction (C), the relation between the contents of Na₂O and K₂O preferably satisfies the following expression (2)

0.9≦Na₂O/(Na₂O+K₂O)≦1.0 (2)

The above expression (2) is an index for decreasing the compaction (C) in the heat treatment at a low temperature (150° C. to 300° C.). To decrease the compaction (C), Na₂O/(Na₂O+K₂O) is preferably 0.95 or more and more preferably 1.0.

(Alkaline-Earth Metal Oxides and Alkali Metal Oxides)

It is known that the devitrification property (T_{id}) and the ratio of the content of the alkaline-earth metal oxides to the total content of the alkaline-earth metal oxides and the alkali metal oxides (MO/(MO+M′₂O)) is in a correlation in the glass for chemical strengthening of this embodiment. To bring the devitrification property (T_{id}) into the above preferable range, MO/(MO+M′₂O) preferably satisfied the following expression (3).

0.20≦MO/(MO+M′₂O)≦0.42 (3)

When the value of MO/(MO+M′₂O) is more than 0.42, the devitrification property (T_{id}) becomes lower than 0° C., easily causing devitrification. Accordingly, in the chemically strengthened glass of this embodiment, the value of MO/(MO+M′₂O) is preferably 0.42 or less, more preferably 0.41 or less, furthermore preferably 0.40 or less, and most preferably 0.39 or less. Further, the value of MO/(MO+M′₂O) is preferably 0.20 or more, more preferably 0.25 or more, furthermore preferably 0.30 or more, and most preferably 0.35 or more. When the value of MO/(MO+M′₂O) is 0.20 or more, the CIE can be kept low.

(Preferable Composition of the Glass for Chemical Strengthening)

The composition of the glass for chemical strengthening of this embodiment has been described for each component in the above. In the above composition range of the glass for chemical strengthening of this embodiment, more preferable compositions will be described below. A composition 1 is advantageous in terms of obtaining a high CS and a low T2. A composition 2 is advantageous in terms of obtaining a higher CS and a lower T2.

(Composition 1)

The composition 1 contains, in mass percentage based on oxides, 61% to 75% of SiO₂, 3% to 10% of Al₂O₃, 6% to 12% of MgO, 0.4% to 6% of CaO, 15% to 19% of Na₂O, and 0% to 1.1% of K₂O.

(Composition 2)

The composition 2 contains, in mass percentage based on oxides, 61% to 75% of SiO₂, 3% to 10% of Al₂O₃, 6% to 12% of MgO, 0.8% to 5% of CaO, 16% to 19% of Na₂O, and 0% to 0.5% of K₂O.

(Other Components)

The glass for chemical strengthening of this embodiment is preferably essentially composed of the above components and may contain other components without impairing the object of the present invention. Specifically, in addition to the above components, alkaline-earth metal oxides other than MgO and CaO, for example, SrO and BaO may be contained by 0% to 1% each. An alkali metal oxide other than Na₂O and K₂O, for example, Li₂O may be contained by 0% to 1%. Further, 0% to 2% of B₂O₃, 0% to 3% of ZrO₂, 0% to 1% of Fe₂O₃, 0% to 1% of TiO₂, and 0% to 2% of ZnO may be contained. Further, 0% to 2% in total of other additive components, 0% to 2% of a fining agent, and 0% to 1% of a coloring agent may be contained. Hereinafter, the case of containing the other components will be described. Note that the content of the other components is preferably 5% or less in total, and more preferably 3% or less in total.

(SrO)

SrO is not essential but may be contained because of an effect of decreasing the viscosity of glass in melting to accelerate melting and improve the devitrification property. On the other hand, too much SrO causes an increase in the compaction (C) and leads to a failure to obtain a sufficient DOL. The amount of SrO when contained is preferably 1% or less, and more preferably 0.5% or less, and it is particularly preferable to contain substantially no SrO. When the content of SrO is 1% or less, an increase in the compaction (C) is suppressed and a sufficient DOL is obtained.

(BaO)

BaO is not essential but may be contained because of an effect of decreasing the viscosity of glass in melting to accelerate melting and improve the devitrification property. On the other hand, too much BaO causes an increase in the compaction (C) and leads to a failure to obtain a sufficient DOL. The amount of BaO when contained is preferably 1% or less, and more preferably 0.5% or less, and it is particularly preferable to contain substantially no BaO. When the content of BaO is 1% or less, an increase in the compaction (C) is suppressed and a sufficient DOL is obtained.

(Li₂O)

Li₂O can be contained because of an effect of decreasing the viscosity of glass in melting to accelerate melting and improve the devitrification property. However, Li₂O is a component that decreases the Tg to easily cause stress relaxation to result in difficulty in obtaining a stable surface compressive stress layer, and therefore is preferably not contained in terms of chemical strengthening property. Further, Li₂O is also a component that may cause an increase in the compaction (C).

From the above viewpoint, the content of Li₂O, even if contained, is preferably less than 1%, more preferably 0.1% or less, and particularly preferably less than 0.01%. Examples of the case of the glass for chemical strengthening of this embodiment containing Li₂O include a case of using cullet containing Li₂O in the above range in the use of cullet obtained by recycling a display panel discarded after use.

(B₂O₃)

B₂O₃ has an effect of decreasing the viscosity of glass in melting to accelerate melting and improve the devitrification property, and may be contained in a range of 2% or less to improve the strength property, and preferably in a range of 1% or less. Generally, B₂O₃ when contained together with an alkaline component such as Na₂O, K₂O and Li₂O causes vigorous volatilization to significantly erode a brick of the glass melting equipment, and therefore it is particularly preferable to contain substantially no B₂O₃.

In the case of using the glass for chemical strengthening as a glass plate for a liquid crystal panel or a glass plate for an in-cell type touch panel, when the B₂O₃ content ratio is low, the volatilization amount of B₂O₃ is low in the melting process, the fining process, and the forming process when melting the glass in manufacturing the glass plate, thus making the glass plate to be manufactured excellent in uniformity and flatness. As a result, in the case of using the glass as the glass plate for a liquid crystal panel required to have high flatness, the glass plate is better in display quality than the conventional glass plate for a liquid crystal panel.

Also in consideration of the environmental burden due to the volatilization of B₂O₃ in melting glass, a lower B₂O₃ content ratio is preferable. However, as with the above Li₂O, in the case of using cullet for the purpose of recycling the glass plate of a display discarded after use, cullet containing B₂O₃ can be used.

(ZrO₂)

ZrO₂ may be contained because of an effect of decreasing the viscosity of glass in melting to accelerate melting and improve the devitrification property, and an effect of improving the CS. On the other hand, an excessive amount of ZrO₂ may cause an increase in the compaction (C). From the above viewpoint, the content of ZrO₂ is preferably 3% or less, more preferably 2% or less, and furthermore preferably 1% or less.

(Fe₂O₃)

Fe₂O₃ is a component that exists anywhere in the natural world and product line and is therefore very difficult to bring its content to zero. It is known that Fe₂O₃ in an oxidation state becomes a cause of coloring yellow, FeO in a reduction state becomes a cause of coloring blue, and glass is colored in green depending on the balance between them. The content of Fe₂O₃ may be typically 0.005% or more. From the viewpoint of avoiding the glass from being colored, the content of Fe₂O₃ is preferably 1% or less, more preferably 0.1% or less, and furthermore preferably 0.05% or less.

(TiO₂)

TiO₂ often exists in natural raw materials and is known to be a source of coloring yellow. The amount of TiO₂, when contained, is preferably 1% or less, more preferably 0.5% or less, and furthermore preferably 0.2% or less. When the content of TiO₂ is 1% or less, the phenomenon that the glass becomes yellowish can be avoided. Note that containing TiO₂ is presumed to contribute to an improvement in the Young's modulus of the glass.

(ZnO)

ZnO may be contained, concretely, up to 2% to improve the meltability of glass at high temperature. As with the above Li₂O, for example, in the case of using cullet for the purpose of recycling the glass plate of a display discarded after use, cullet containing ZnO can be used. However, when glass is manufactured by the float method, the glass is reduced in a float bath into a defective product, and therefore ZnO is preferably not contained.

(Other Additional Components)

The other additional components refer to components to be added for the purpose of, for example, improving the chemical durability, weather resistance, meltability, devitrification property, ultraviolet shielding, infrared shielding, ultraviolet transmission, infrared transmission and so on other than the above components. The other additional components may be contained by 2% or less, and preferably 1% or less, in total, and more preferably can be contained by 0.5% or less in total.

As examples of the other additional components, Y₂O₃, La₂O₃ and the like, may be contained in the glass by 2% or less in total to improve the chemical durability of the glass and improve the Young's modulus of the glass. Also, as impurity mixture due to use of cullet by recycling a display panel discarded after use, WO₃, Nb₂O₅, V₂O₅, Bi₂O₃, MoO₃, P₂O₅, Ga₂O₃, In₂O₃, GeO₂ and the like may be contained.

(Fining Agent)

To improve the meltability and fining property of the glass for chemical strengthening of this embodiment, raw materials of SO₃, F, Cl and SnO₂ may be added to the glass raw material so that SO₃, F, Cl and SnO₂ are contained in the glass by 2% or less in total.

(Coloring Agent)

To adjust the color tone of the glass for chemical strengthening of this embodiment, coloring agents such as CeO₂ may be contained in the glass other than the above Fe₂O₃. The content of the coloring agents is preferably 1% or less in total.

The glass for chemical strengthening of this embodiment preferably contains substantially no As₂O₃, Sb₂O₃ in consideration of the environmental burden. Besides, in consideration of stable float forming, the glass for chemical strengthening of this embodiment preferably contains substantially no ZnO. The glass for chemical strengthening of this embodiment is more effective for application to thin glass made at high glass drawing speed and glass forming by the fusion method.

The shape of the glass for chemical strengthening of this embodiment is not particularly limited. According to the use, a plate shape, a cylindrical shape, a spherical shape or the like is appropriately selected. In the case where the shape of the glass for chemical strengthening is a plate shape, the shape may be a flat plate or a curved plate subjected to bending process.

<Manufacture of the Glass for Chemical Strengthening>

The glass for chemical strengthening of this embodiment is obtained by preparing the glass raw material so that the composition of the glass to be obtained has the above composition in mass percentage based on oxides, and melting and cooling the glass raw material by an ordinary method. Note that after melting, the glass is formed into a desired shape and cooled. Examples of the forming method include already-known glass forming methods such as a float method, a fusion method, a slot down draw method, and so on.

The glass for chemical strengthening of this embodiment is formed by the existing forming methods and formed into dimensions formable by the respective forming methods, for example, formed by the float method into glass in a continuous ribbon shape with a width of the float forming and cooled, and then finally cut into later-described sizes suitable for various intended uses and subjected to chemical strengthening. The glass for chemical strengthening of this embodiment is generally cut into a rectangle, but may be cut into another shape such as a circle or a polygon, and may be subjected to drilling process or the like.

The glass for chemical strengthening of this embodiment can be preferably used as a plate-shape glass for chemical strengthening suitable for a display member. Hereinafter, the manufacturing method of the glass for chemical strengthening of this embodiment will be described using the glass plate for chemical strengthening for a display member as an example.

When the glass for chemical strengthening of this embodiment is manufactured as a glass plate, the glass for chemical strengthening undergoes melting, fining, forming and slow cooling processes as in manufacturing the conventional glass plate for a liquid crystal panel or glass plate for cover glass.

The melting process is a process of preparing a raw material to have a composition of the glass plate to be obtained, continuously putting the raw material into a melting furnace, and heating the raw material to about 1450° C. to 1650° C. to thereby obtain molten glass. For the raw material, an oxide, a carbonate, a hydroxide, and possibly a halide such as a chloride can be used. As for the grain size of the raw material, any raw material from a raw material having a large grain diameter of about several hundreds of microns which does not cause unmelted residual to a raw material having a small grain diameter of about several microns which does not cause scattering during transport of the raw material and does not cause aggregation as a secondary particle, can be appropriately used. A granule can also be used. The melting conditions such as moisture content, namely, β-OH, and the degree of oxidation/reduction of Fe, namely, the redox (Fe²⁺/(Fe²⁻+Fe³⁺)) can be appropriately adjusted and used.

In the fining process, the glass for chemical strengthening of this embodiment is alkali glass containing the alkali metal oxides (Na₂O, K₂O) and therefore can effectively use SO₃ as a fining agent. Also, a defoaming method by pressure reduction may be applied. As a fining agent in the defoaming method by pressure reduction, halogen such as Cl or F is preferably used.

The float method or the fusion method (down draw method) is applied as the forming process to obtain a glass ribbon. As the slow cooling process, the glass ribbon is cooled down to room temperature at a predetermined cooling rate, then cut, and thereafter a glass plate is obtained. Note that the cooling rate refers to a cooling rate of the glass plate in a range from Tg+50° C. to Tg−120° C. in the slow cooling process after melting the raw material and forming the raw material into a plate shape.

In the case of using as the glass plate for chemical strengthening for a display member, the thickness of the glass plate obtained in the above is preferably 2 mm or less. The thickness of the glass plate when 2 mm or less can contribute to reductions in thickness and in weight of a display or a sensor-integrated cover glass mounting product. The thickness is preferably 1.5 mm or less, more preferably 1.0 mm or less, furthermore preferably 0.5 mm or less, and moreover preferably 0.3 mm or less.

Note that in the case of forming the glass for chemical strengthening of this embodiment into a plate shape, the thickness of the glass plate is not limited to the above. The thickness of the glass plate is appropriately selected according to the use thereof.

In the case of the glass composition having a difficulty in obtaining high DOL such as soda lime silicate glass containing CaO, it is conceivable to increase the cooling rate in the slow cooling process in order to obtain high DOL. This is because the increasing the cooling rate coarsens the glass structure to increase the ion exchange rate, resulting in increased DOL.

In the manufacture of the above glass for chemical strengthening, the compaction (C1) and the compaction (C2) become smaller at a lower cooling rate in the slow cooling process. The cooling rate in the slow cooling process of the manufacture of the glass for chemical strengthening of this embodiment is preferably 300° C./min or less, more preferably 200° C./min or less, and furthermore preferably 140° C./min or less. On the other hand, to improve the production efficiency, a higher cooling rate is preferable. The cooling rate in the slow cooling process of the manufacture of the glass for chemical strengthening of this embodiment is preferably 30° C./min or more, more preferably 50° C./min or more, and furthermore preferably 70° C./min or more. The cooling rate set to not less than 30° C./min nor more than 300° C./min can sufficiently suppress the increase in the compaction (C) while keeping the appropriate production efficiency.

In the above manufacture of the glass for chemical strengthening, the cooling rate in the slow cooling process cannot be set to about 30° C./min or more, in particular, about 50° C./min or more in the conventional glass for chemical strengthening because the compaction (C1) and the compaction (C2) increase. Use of the glass for chemical strengthening of this embodiment makes it possible to set the compaction (C1) and the compaction (C2) to very low values such as 25 ppm or less in the glass for chemical strengthening to be obtained even in the case of performing the cooling at a rate of 30° C./min or more, in particular, 50° C./min or more.

In manufacture of glass, increasing the cooling rate shortens the cooling time to greatly improve the production efficiency. In this embodiment, a glass for chemical strengthening in which the compaction (C1) and the compaction (C2) can be set to 25 ppm or less at a cooling rate of 70° C./min or more is more preferable, and a glass for chemical strengthening in which the compaction (C1) and the compaction (C2) can be set to 25 ppm or less at a cooling rate of 200° C./min or more is particularly preferable.

The thus-obtained glass for chemical strengthening of this embodiment has the above composition, has the above-describe glass characteristic (1), has a low compaction in the heat treatment at a low temperature (150° C. to 300° C.) in the manufacturing process of the display member such that the compaction (C1) by the above measuring method can be preferably set to 25 ppm or less, for example, in the plate shape, and causes less positional displacement in film-forming and patterning on the glass plate.

Accordingly, the glass for chemical strengthening of this embodiment can be preferably used as a glass for chemical strengthening coping with large size and high definition of a panel, high speed, high weather resistance, high functionality, and high reliability of a display frame, and built-in of an IC circuit of a driver or the like, in particular, for an integrated-type cover glass for a touch panel sensor.

Further, the glass for chemical strengthening of this embodiment is also applicable to glass manufactured by the forming method at a high cooling rate in the fusion method or the like.

Further, the glass for chemical strengthening of this embodiment, when subjected to chemical strengthening into a chemically strengthened glass, is high in surface compressive stress and is likely to have a surface compressive stress layer deep therein, and has a high strength as a display member. Hereinafter, the chemically strengthened glass of this embodiment obtained by chemically strengthening the glass for chemical strengthening of this embodiment will be described.

<Chemical Strengthening>

The chemical strengthening can be performed by the conventional publicly-known method. Note that it is preferable to perform, when necessary, shape machining according to the use, for example, mechanical processing such as cutting, edge dressing and drilling, etching, polishing or annealing, prior to the chemical strengthening. Note that the above processing and treatment may be performed when necessary after the chemical strengthening, but are preferably performed without impairing the chemically strengthening effect by the chemical strengthening. The methods of the above processing and treatment can be executed by publicly-known methods without any limitation.

The chemical strengthening brings the glass into contact with a melt of an alkali metal salt (for example, a potassium nitrate salt) containing an alkali metal ion (typically, a K⁺ ion) having a large ion diameter by immersion, thereby replacing a metal ion (typically, a Na⁺ ion) having a small ion diameter in the glass with the metal ion having the large ion diameter.

The chemical strengthening can be performed, for example, by immersing the glass in a potassium nitrate molten salt at 340° C. to 550° C. for 5 minutes to 20 hours. As the ion exchange condition, an optimal condition only needs to be selected in consideration of the viscosity characteristics, use, thickness of the glass, and the tensile stress inside the glass and so on.

Examples of the molten salt for ion exchange treatment include an alkali nitrate salt, an alkali sulfate salt, and an alkali chloride salt such as a potassium nitrate salt, a potassium sulfate salt, and a potassium chloride salt. The molten salts may be used individually or a plurality of them may be used in combination. Further, to adjust the chemical strengthening property, a salt containing sodium may be mixed.

In the present invention, the treatment condition of the chemical strengthening is not particularly limited, and an optimal condition only needs to be selected in consideration of the kind of the characteristics of the glass and the molten salt in use.

<Chemically Strengthened Glass>

The chemically strengthened glass of this embodiment obtained by chemically strengthening the glass for chemical strengthening of this embodiment includes a compressive stress layer on the surface by an ion exchange treatment. The chemically strengthened glass of this embodiment obtained by using the glass for chemical strengthening of this embodiment has the above-described glass characteristic (2), and has a low compaction in the heat treatment at a low temperature (150° C. to 300° C.) in the manufacturing process of the display member such that the compaction (C2) by the above measuring method can be set to of 25 ppm or less, for example, in the plate shape, and causes less positional displacement in film-forming and patterning on the glass plate.

The chemically strengthened glass of this embodiment preferably has a CS of 300 MPa or more as described in the glass characteristic (2), more preferably 500 MPa or more, and furthermore preferably 600 MPa or more. Further, when the thickness of the glass is below 2 mm, the CS is preferably 1400 MPa or less. When the CS is more than 1400 MPa, the internal tensile stress (CT) may excessively increase. The CS is more preferably 1000 MPa or less, and typically 900 MPa or less.

A scratch beyond the depth of the surface compressive stress layer, if made during use of the chemically strengthened glass, leads to breakage of the glass. Therefore, a deeper surface compressive stress layer is more preferable, and the DOL is preferably 8 μm or more, more preferably 9 μm or more, and furthermore preferably 10 μm or more. When the thickness of the glass is below 2 mm, the DOL is preferably 50 μm or less. When the DOL is more than 50 μm, the internal tensile stress (CT) may excessively increase. The DOL is more preferably 40 μm or less, and typically 30 μm or less. Further, to enable cutting after the chemical strengthening, the DOL is preferably 25 μm or less, and more preferably 20 μm or less.

Further, the internal tensile stress (CT) of the chemically strengthened glass expressed by the following expression (4) is preferably 50 MPa or less. The internal tensile stress (CT) is preferably 45 MPa or less, more preferably 40 MPa or less, and most preferably 30 MPa or less.

CT=CS×DOL/(t−2×DOL) (4)

In the above expression (4), t is the thickness (μm) of the glass plate. A large CT increases the tendency for the glass to scatter in small pieces when the glass is broken.

The chemically strengthened glass of this embodiment preferably has on the surface at least one kind selected from a group consisting of a sodium ion, a silver ion, a potassium ion, a cesium ion, and a rubidium ion. This induces a compression stress on the surface to increase the strength of the glass. Further, the silver ion provided on the surface can impart the antibacterial property.

The chemically strengthened glass of this embodiment forms into a chemically strengthened glass product as it is or after processed. Examples of the chemically strengthened glass product include a cover glass of a display device or the like and a glass substrate of a display.

The use of the chemically strengthened glass of this embodiment is not particularly limited. Because of a high mechanical strength, the chemically strengthened glass is suitable for the use at a place where the chemically strengthened glass is anticipated to receive an impact due to falling or to come into contact with other substances.

Concrete examples of the use include use for protecting machines or instruments such as: cover glass for a display part of a cellular phone handset (including a multifunctional information terminal such as a smart phone), a PHS, a PDA, a tablet terminal, a notebook personal computer, a game machine, a portable music and video player, an electronic book, an electronic terminal, a timepiece, a camera, or a GPS, and cover glass of a monitor for operating a touch panel of these instruments; cover glass for a cooking device such as a microwave oven, a toaster oven, or the like; cover glass of instruments such as a top plate, a meter, a gauge or the like of an electromagnetic cooking device or the like; and a glass plate for a reading part of a copying machine, a scanner, or the like.

Other examples of the use include: glass for window of a vehicle, a ship, an aircraft or the like; cover glass of a lighting equipment for household or industry, a traffic light, a guide light, or an electronic message board; a showcase, a bulletproof glass and so on. Other examples of the use include cover lass for protecting a solar cell, and a glass material for light condensing for increasing the power generation efficiency of the solar cell.

Other examples of the use include: a water tank, table wear such as a dish, or a drinking cup; various cooking devices such as a bottle, or a cutting board; a shelf board of a cupboard or a refrigerator; and building materials for a wall, a roof, or a partition.

In addition to the above uses, the chemically strengthened glass manufactured after finishing chemical strengthening is optimal as a glass material for a display installed in various image display apparatuses such as liquid crystal, plasma, organic EL image display devices.

### EXAMPLES

Hereinafter, the present invention will be concretely described using examples, but the present invention is not limited by these examples. Note that Examples 1 to 8 are examples, and Examples 9 to 15 are comparative examples.

### Examples 1 to 15

### (Fabrication of Glass for Chemical Strengthening)

The raw materials of components for fabricating the glass for chemical strengthening were prepared for the compositions (in mass percentage and in molar percentage based on oxides) listed in Table 1 and Table 2. Relative to 100 parts by mass of the raw material components for glass, 0.1 parts by mass of sulfate in terms of SO₃ was added to the raw material for glass, and they were melted by heating for 3 hours at a temperature of 1600° C. using a platinum crucible. For the melting, a platinum stirrer was inserted to perform stirring for 1 hour for homogenization of the glass. Then, the molten glass was drawn out, retained at Tg+50° C. for 1 hour, and then cooled at 1° C./min. After the cooling, the glass was subjected to grinding and polishing into a plate shape to provide glass for chemical strengthening in each of Examples 1 to 15. In each of the examples, a plurality of glass plates for measuring physical properties and glass plates for chemical strengthening were obtained.

The glass plates for measuring physical properties were separately prepared for measuring the specific gravity, for measuring the glass transition point and the CTE, for measuring the compaction, and for measuring the T₂, T₄, T_{L}. Note that the glass plate for measuring the compaction and the glass plate for chemical strengthening were in a flat plate shape and had a size of 100 mm×10 mm and a thickness of 1 mm.

To prepare glasses varied in cooling rate, all of the glasses for chemical strengthening obtained in the above were retained at Tg+50° C. for 1 minute in an infrared oven and then cooled at a predetermined cooling rate. Note that retaining at Tg+50° C. for 1 minute can cancel the thermal history before the retaining at the temperature. Accordingly, the cooling rate after retaining at Tg+50° C. for 1 minute can be recognized as a cooling rate in the slow cooling process after forming.

Glass plates for chemical strengthening were obtained with the above predetermined cooing rate set to four kinds such as 1° C./min, 50° C./min, 70° C./min, and 200° C./min. Not that in the following description, the four kinds of glass plates for chemical strengthening obtained in the examples are indicated by the following abbreviations.

The glass plate for chemical strengthening obtained at a cooling rate of 1° C./min; a glass plate A,

The glass plate for chemical strengthening obtained at a cooling rate of 50° C./min; a glass plate B,
The glass plate for chemical strengthening obtained at a cooling rate of 70° C./min; a glass plate C, and
The glass plate for chemical strengthening obtained at a cooling rate of 200° C./min; a glass plate D.

Further, the cooling rate was set to 50° C./min for all of the glass plates for measuring physical properties. The glass plate will be referred to as the glass plate B as with the glass plate for chemical strengthening.

Here, in the case of glass whose cooling rate is unclear, the cooling rate can be found by creating a calibration curve. The calibration curve can be created from a straight line made by plotting the measured value of the refractive index and the logarithm of the cooling rate. After retaining the glass at Tg+50° C. for 1 minute or more, the glass was cooled at a predetermined cooling rate and subjected to measurement of the refractive index. To fabricate a glass at a cooling rate of lower than 10° C./min, a resistance-heating electric furnace or an infrared oven can be used. To fabricate a glass at a cooling rate of 10° C./min or more, it is preferable to use an infrared oven with good temperature followability. An infrared oven is used with which a certain cooling rate can be obtained at least in a region of Tg+50° C. to Tg−120° C.

(Fabrication of Chemically Strengthened Glass)

A chemically strengthened glass C was obtained by chemically strengthening the glass plate C obtained in each of the examples by immersing it in a molten salt of 97.8 mass % of KNO₃ and 2.2 mass % of NaNO₃ at 425° C. for 150 minutes (condition 1).

A chemically strengthened glass A, a chemically strengthened glass B, and a chemically strengthened glass D were obtained by chemically strengthening the glass plate A, the glass plate B, and the glass plate D obtained in each of the examples by immersing them in a molten salt of 100 mass % of KNO₃ at 425° C. for 120 minutes (condition 2).

The glasses for chemical strengthening obtained in the above were subjected to the following evaluation (1). The measurement was performed using the glass plate B (the glass plate for measuring physical property). The chemically strengthened glasses A to D were also subjected to the following evaluation (2). The results are listed in Table 1 and Table 2.

[Evaluation Method]

### Evaluation (1)

### (1-1) Specific Gravity

The specific gravity was measured by the Archimedean method.

### (1-2) Glass Transition Point (Tg)

The glass transition point was measured by a thermomechanical analyzer (TMA manufactured by Bruker AXS K.K., TD5000SA).

(1-3) High-Temperature Viscosity (T₂,T₄)

The temperature (T₂) at which the viscosity became 10² dPa·s and the temperature (T₄) at which the viscosity became 10⁴ dPa·s were measured using a rotational viscometer (manufactured by MOTOYAMA Co., Ltd., GM series).

### (1-4) CTE

The CTE was measured at a temperature rise rate of 5° C./min using a thermal dilatometer (TMA, manufactured by Bruker AXS K.K., TD5000SA) at the same time with the measurement of the glass transition point (Tg) on the basis of JIS R 1618: 2002, and an average linear thermal expansion coefficient at 50° C. to 350° C. was found.

(1-5) Devitrification Temperature (T_{L}) and Devitrification Property (T_{id})

For the devitrification temperature, the glass was crushed into glass grains of about 2 mm in a mortar, the glass grains were set out on a platinum boat and subjected to heat treatment for 24 hours in increments of 10° C. in a temperature gradient furnace. The highest value of the temperature of the glass grains at which crystals precipitated was regarded as the devitrification temperature (T_{L}). The devitrification property (T_{id}) was calculated by the above expression (1) from T₄ and T_{L}.

### (1-6) Compaction (C1)

The compaction (C1) was measured by the above method.

### Evaluation (2)

### (2-1) Surface Compressive Stress (CS) and Depth of Surface Compressive Stress Layer (DOL)

The CS and the DOL of the chemically strengthened glasses A to D were measured by the surface stress meter FSM-6000 manufactured by Orihara Industrial Co., Ltd.

### (2-2) Compaction (C2)

For the chemically strengthened glass A, the chemically strengthened glass B, and the chemically strengthened glass D, the compaction (C2) was measured by the above method.

TABLE 1

| | | | E1 | E2 | E3 | E4 | E5 | E6 | E7 | E8 |
|---|---|---|---|---|---|---|---|---|---|---|
| Glass composition | | SiO₂ | 66.8 | 68.1 | 68.0 | 67.8 | 67.7 | 67.4 | 65.6 | 68.2 |
| [mass %] | | Al₂O₃ | 5.6 | 5.9 | 5.9 | 5.9 | 5.9 | 5.9 | 5.3 | 4.4 |
| | | MgO | 7.3 | 9.5 | 9.0 | 8.2 | 7.7 | 6.7 | 9.4 | 7.7 |
| | | CaO | 1.0 | 0.3 | 1.0 | 2.0 | 2.7 | 4.0 | 1.0 | 3.8 |
| | | SrO | 0.0 | 0.0 | 0.0 | 0.0 | 0.0 | 0.0 | 0.0 | 0.0 |
| | | BaO | 0.0 | 0.0 | 0.0 | 0.0 | 0.0 | 0.0 | 0.0 | 0.0 |
| | | ZrO₂ | 2.7 | 0.0 | 0.0 | 0.0 | 0.0 | 0.0 | 1.9 | 0.0 |
| | | Na₂O | 16.6 | 16.1 | 16.1 | 16.1 | 16.0 | 16.0 | 16.8 | 14.9 |
| | | K₂O | 0.0 | 0.0 | 0.0 | 0.0 | 0.0 | 0.0 | 0.0 | 1.0 |
| | | TOTAL | 100.0 | 100.0 | 100.0 | 100.0 | 100.0 | 100.0 | 100.0 | 100.0 |
| Na₂O/(Na₂O + K₂O) | | | 1.0 | 1.0 | 1.0 | 1.0 | 1.0 | 1.0 | 1.0 | 0.9 |
| M′₂O | | | 16.6 | 16.1 | 16.1 | 16.1 | 16.0 | 16.0 | 16.8 | 16.0 |
| MO | | | 8.3 | 9.8 | 10.0 | 10.3 | 10.4 | 10.8 | 10.4 | 11.5 |
| MO/(MO + M′₂O) | | | 0.33 | 0.38 | 0.38 | 0.39 | 0.39 | 0.40 | 0.38 | 0.42 |
| Glass composition | | SiO₂ | 67.2 | 66.9 | 66.9 | 66.9 | 66.9 | 66.9 | 64.9 | 67.2 |
| [mol %] | | Al₂O₃ | 3.3 | 3.4 | 3.4 | 3.4 | 3.4 | 3.4 | 3.1 | 2.5 |
| | | MgO | 10.9 | 14.0 | 13.2 | 12.1 | 11.4 | 10.0 | 13.9 | 11.3 |
| | | CaO | 1.1 | 0.3 | 1.1 | 2.1 | 2.9 | 4.3 | 1.1 | 4.0 |
| | | SrO | 0.0 | 0.0 | 0.0 | 0.0 | 0.0 | 0.0 | 0.0 | 0.0 |
| | | BaO | 0.0 | 0.0 | 0.0 | 0.0 | 0.0 | 0.0 | 0.0 | 0.0 |
| | | ZrO₂ | 1.3 | 0.0 | 0.0 | 0.0 | 0.0 | 0.0 | 0.9 | 0.0 |
| | | Na₂O | 16.1 | 15.4 | 15.4 | 15.4 | 15.4 | 15.4 | 16.1 | 14.3 |
| | | K₂O | 0.0 | 0.0 | 0.0 | 0.0 | 0.0 | 0.0 | 0.0 | 0.6 |
| | | TOTAL | 100.0 | 100.0 | 100.0 | 100.0 | 100.0 | 100.0 | 100.0 | 100.0 |
| Cooling | Chemical | Glass | | | | | | | | |
| rate ° C./min | strengthening | characteristics | | | | | | | | |
| 50 | — | Tg [° C.] | 582 | 588 | 580 | 569 | 569 | 564 | 583 | 560 |
| | | T₂ [° C.] | 1501 | 1493 | 1492 | 1480 | 1475 | 1464 | 1456 | 1453 |
| | | T₄ [° C.] | 1100 | 1081 | 1085 | 1069 | 1064 | 1055 | 1069 | 1050 |
| | | T_{L} [° C.] | 960 | 1120 | 1030 | 1040 | 1050 | 1080 | 1030 | 1060 |
| | | T_{id} [° C.](T₄ − T_{L}) | >140 | −39 | 55 | 29 | 14 | −25 | 39 | −10 |
| | | CTE [×10⁻⁷/° C.] | 91 | 88 | 92 | 93 | 92 | 93 | 91 | 92 |
| | | Specific gravity | 2.496 | 2.463 | 2.468 | 2.478 | 2.482 | 2.490 | 2.506 | 2.491 |
| | | Compaction(C1) | 13 | 7 | 11 | 11 | 10 | 13 | 15 | 22 |
| | | [ppm] | | | | | | | | |
| 70 | Condition 1 | CS [MPa] | 800 | 752 | 761 | 742 | 738 | 730 | 844 | 705 |
| | | DOL [μm] | 16 | 15 | 15 | 13 | 13 | 11 | 12 | 11 |
| 1 | Condition 2 | CS [MPa] | 1051 | | 1023 | | | | | |
| | | DOL [μm] | 13 | | 12 | | | | | |
| 50 | | CS [MPa] | 952 | | 914 | | | | | |
| | | DOL [μm] | 15 | | 15 | | | | | |
| 200 | | CS [MPa] | 927 | | 900 | | | | | |
| | | DOL [μm] | 16 | | 15 | | | | | |
| 1 | | Compaction(C2) | 13 | | 12 | | | | | |
| | | [ppm] | | | | | | | | |
| 50 | | Compaction(C2) | 15 | | 13 | | | | | |
| | | [ppm] | | | | | | | | |
| 200 | | Compaction(C2) | 17 | | 15 | | | | | |
| | | [ppm] | | | | | | | | |

E1 to E8 = Example 1 to Example 8
<Chemically strengthening condition>
Condition 1: 425° C., 97.8% of potassium nitrate, 2.2% of sodium nitrate, immersion for150 minutes
Condition 2: 425° C., 100% of potassium nitrate, immersion for 120 minutes

TABLE 2

| | | | E9 | E10 | E11 | E12 | E13 | E14 | E15 |
|---|---|---|---|---|---|---|---|---|---|
| Glass composition | | SiO₂ | 66.7 | 66.3 | 65.7 | 67.9 | 66.1 | 64.3 | 72.1 |
| [mass %] | | Al₂O₃ | 5.8 | 5.8 | 5.7 | 1.0 | 6.3 | 7.8 | 1.9 |
| | | MgO | 3.8 | 2.4 | 0.0 | 9.0 | 3.9 | 5.5 | 4.6 |
| | | CaO | 8.0 | 9.9 | 13.1 | 1.0 | 7.8 | 2.6 | 7.8 |
| | | SrO | 0.0 | 0.0 | 0.0 | 0.0 | 0.0 | 0.0 | 0.0 |
| | | BaO | 0.0 | 0.0 | 0.0 | 0.0 | 0.0 | 0.0 | 0.0 |
| | | ZrO₂ | 0.0 | 0.0 | 0.0 | 0.0 | 0.0 | 2.0 | 0.0 |
| | | Na₂O | 15.8 | 15.7 | 15.6 | 16.1 | 12.3 | 15.8 | 13.3 |
| | | K₂O | 0.0 | 0.0 | 0.0 | 5.0 | 3.5 | 2.0 | 0.3 |
| | | TOTAL | 100.0 | 100.0 | 100.0 | 100.0 | 100.0 | 100.0 | 100.0 |
| Na₂O/(Na₂O + K₂O) | | | 1.0 | 1.0 | 1.0 | 0.8 | 0.8 | 0.9 | 1.0 |
| M′₂O | | | 15.8 | 15.7 | 15.6 | 21.1 | 15.8 | 17.8 | 13.6 |
| MO | | | 11.8 | 12.3 | 13.1 | 10.0 | 11.8 | 8.1 | 12.4 |
| MO/(MO + M′₂O) | | | 0.43 | 0.44 | 0.46 | 0.32 | 0.43 | 0.31 | 0.48 |
| Glass composition | | SiO₂ | 66.9 | 66.9 | 66.9 | 66.7 | 67.3 | 66.0 | 70.9 |
| [mol %] | | Al₂O₃ | 3.4 | 3.4 | 3.4 | 0.6 | 3.8 | 4.7 | 1.1 |
| | | MgO | 5.7 | 3.6 | 0.0 | 13.2 | 6.0 | 8.4 | 6.7 |
| | | CaO | 8.6 | 10.7 | 14.3 | 1.1 | 8.5 | 2.8 | 8.3 |
| | | SrO | 0.0 | 0.0 | 0.0 | 0.0 | 0.0 | 0.0 | 0.0 |
| | | BaO | 0.0 | 0.0 | 0.0 | 0.0 | 0.0 | 0.0 | 0.0 |
| | | ZrO₂ | 0.0 | 0.0 | 0.0 | 0.0 | 0.0 | 1.0 | 0.0 |
| | | Na₂O | 15.4 | 15.4 | 15.4 | 15.3 | 12.1 | 15.8 | 12.7 |
| | | K₂O | 0.0 | 0.0 | 0.0 | 3.1 | 2.3 | 1.3 | 0.2 |
| | | TOTAL | 100.0 | 100.0 | 100.0 | 100.0 | 100.0 | 100.0 | 100.0 |
| Cooling | Chemical | Glass | | | | | | | |
| rate ° C./min | strengthening | characteristics | | | | | | | |
| 50 | — | Tg [° C.] | 564 | 567 | 579 | 513 | 565 | 563 | 563 |
| | | T₂ [° C.] | 1434 | 1419 | 1395 | 1370 | 1464 | 1496 | 1447 |
| | | T₄ [° C.] | 1028 | 1015 | 993 | 978 | 1055 | 1086 | 1039 |
| | | T_{L} [° C.] | 1060 | 1080 | 1150 | <900 | 1050 | 970 | 1030 |
| | | T_{id} [° C.](T₄ − T_{L}) | −32 | −65 | −157 | >78 | 5 | 116 | 9 |
| | | CTE [×10⁻⁷/° C.] | 97 | 94 | 100 | 114 | 98 | 101 | 88 |
| | | Specific gravity | 2.521 | 2.531 | 2.550 | 2.478 | 2.523 | 2.512 | 2.492 |
| | | Compaction(C1) | 13 | 18 | 21 | 28 | 33 | 26 | 25 |
| | | [ppm] | | | | | | | |
| 70 | Condition 1 | CS [MPa] | 707 | 696 | 678 | 545 | 618 | 771 | 542 |
| | | DOL [μm] | 7 | 5 | 2 | 20 | 12 | 18 | 6 |
| 1 | Condition 2 | CS [MPa] | | | | | | | |
| | | DOL [μm] | | | | | | | |
| 50 | | CS [MPa] | | | | | | | |
| | | DOL [μm] | | | | | | | |
| 200 | | CS [MPa] | | | | | | | |
| | | DOL [μm] | | | | | | | |
| 1 | | Compaction(C2) | | | | | | | |
| | | [ppm] | | | | | | | |
| 50 | | Compaction(C2) | | | | | | | |
| | | [ppm] | | | | | | | |
| 200 | | Compaction(C2) | | | | | | | |
| | | [ppm] | | | | | | | |

E9 to E15 = Example 9 to Example 15
<Chemically strengthening condition>
Condition 1: 425° C., 97.8% of potassium nitrate, 2.2% of sodium nitrate, immersion for 150 minutes
Condition 2: 425° C., 100% of potassium nitrate, immersion for 120 minutes

As is found from Table 1 and Table 2, each of the glasses for chemical strengthening according to the present invention and the chemically strengthened glasses obtained by chemically strengthening the glasses can be said to have both of a compaction (C1) and a compaction (C2) of 25 ppm or less, have a low compaction in the heat treatment at a low temperature (150° C. to 300° C.) in the manufacturing process of the display member, and cause less positional displacement in film-forming and patterning on the glass plate.

Further, the chemically strengthened glasses obtained by chemically strengthening the glasses for chemical strengthening according to the present invention have sufficient CS and DOL and have both of a compaction (C1) and a compaction (C2) of 25 ppm or less even when manufactured by the forming method at a high cooling rate. Further, the devitrification property (T_{id}) is also excellent. The glasses for chemical strengthening in comparative examples have insufficient compaction (C1) or insufficient DOL when the glasses are formed into chemically strengthened glasses.

While the present invention has been described in detail and referring to specific embodiments, it is apparent to a person skilled in the art that various changes and modifications may be made to the embodiments without departing from the spirit and scope of the present invention.

The glass for chemical strengthening of the present invention is suitable, as the chemically strengthened glass of the present invention obtained by chemically strengthening the glass, for a glass plate for a liquid crystal display member having a touch panel sensor. Further, the chemically strengthened glass can be used for a plate for another display having a touch panel sensor, for example, a plasma display panel (PDP), an inorganic electroluminiscence display or the like. Further, the chemically strengthened glass can be used for a double glass for a building and house or a solar cell substrate.

What is claimed is:

1. A glass for chemical strengthening obtained by melting and cooling a glass raw material, comprising, in mass percentage based on oxides,
61% to 75% of SiO₂,
2.5% to 10% of Al₂O₃,
6% to 12% of MgO,
0.1% to 8% of CaO,
14% to 19% of Na₂O, and
0% to 1.8% of K₂O.

2. The glass for chemical strengthening according to claim 1,
wherein a content of the Na₂O is 15.5% or less, in molar percentage based on an oxide, and
a glass transition point of the glass is lower than 580° C.

3. The glass for chemical strengthening according to claim 1,
wherein a content of the Na₂O is more than 15.5%, in molar percentage based on an oxide.

4. The glass for chemical strengthening according to claim 1, comprising, in mass percentage based on oxides,
61% to 75% of SiO₂,
3% to 10% of Al₂O₃,
6% to 12% of MgO,
0.4% to 6% of CaO,
15% to 19% of Na₂O, and
0% to 1.1% of K₂O.

5. The glass for chemical strengthening according to claim 4, comprising, in mass percentage based on oxides,
61% to 75% of SiO₂,
3% to 10% of Al₂O₃,
6% to 12% of MgO,
0.8% to 5% of CaO,
16% to 19% of Na₂O, and
0% to 0.5% of K₂O.

6. The glass for chemical strengthening according to claim 1,
wherein a temperature (T₂) at which a viscosity becomes 10² d·Pa·s is 1600° C. or lower.

7. The glass for chemical strengthening according to claim 1,
wherein a compaction (C1) measured by the following method is 25 ppm or less,
the measuring method comprising: heating a sample with a size of 100 mm×10 mm×1 mm up to a glass transition point +50° C., retaining the sample at the temperature for 1 minute, and then cooling the sample down to room temperature at a temperature drop rate of 50° C./min; thereafter making indentations at two positions at an interval of A1 (A1=90 mm) in a long side direction on a surface of the sample using a Vickers hardness testing machine while observing the sample under an optical microscope; heating the sample with indentations up to 300° C. at a temperature rise rate of 100° C./h (=1.6° C./min), retaining the sample at 300° C. for 1 hour, and then cooling the sample down to room temperature at a temperature drop rate of 100° C./h; measuring an interval B1 (mm) between the indentations under the optical microscope; and finding a compaction (C1) by the following expression,
Compaction (C1) [ppm]=(A1−B1)/A1×10⁶.

8. The glass for chemical strengthening according to claim 1,
wherein a cooling rate after the melting is not less than 30° C./min nor more than 300° C./min.

9. The glass for chemical strengthening according to claim 8,
wherein the cooling rate after the melting is 50° C./min or more.

10. The glass for chemical strengthening according to claim 1, further comprising 0% to 1% of BaO in mass percentage based on an oxide.

11. The glass for chemical strengthening according to claim 1, further comprising 0% to 2% of B₂O₃ in mass percentage based on an oxide.

12. The glass for chemical strengthening according to claim 1, further comprising 0% to 1% of Fe₂O₃ in mass percentage based on an oxide.

13. The glass for chemical strengthening according to claim 1, further comprising 0% to 1% of TiO₂ in mass percentage based on an oxide.

14. A chemically strengthened glass obtained by chemically strengthening the glass for chemical strengthening according to claim 1.

15. The chemically strengthened glass according to claim 14,
wherein a compaction (C2) measured by the following method is 25 ppm or less,
the measuring method comprising: preparing a sample with a size of 100 mm×10 mm×1 mm; making indentations at two positions at an interval of A2 (A2=90 mm) in a long side direction on a surface of the sample using a Vickers hardness testing machine while observing the sample under an optical microscope; heating the sample with indentations up to 300° C. at a temperature rise rate of 100° C./h (=1.6° C./min), retaining the sample at 300° C. for 1 hour, and then cooling the sample down to room temperature at a temperature drop rate of 100° C./h; measuring an interval B2 (mm) between the indentations under the optical microscope; and finding a compaction (C2) by the following expression,
Compaction (C2) [ppm]=(A2−B2)/A2×10⁶.

16. The chemically strengthened glass according to claim 14,
wherein a surface compressive stress is 300 MPa or more.
